(19) United States
(12) Patent Application Publication
(10) Pub. No.: US 2007/0245821 A1
(43) Pub. Date: Oct. 25, 2007

(54) Luminescent refrigerant gauge device

(76) Inventor: Ching-Su Chiu, Taiping City (TW)

Correspondence Address: COOPER & DUNHAM, LLP, 1185 AVENUE OF THE AMERICAS, NEW YORK, NY, 10036, US

(21) Appl. No.: 11/402,144

(22) Filed: Apr. 11, 2006

(51) Int. Cl. G01F 7/00; F25B 45/00

(52) U.S. Cl. 73/197; 62/292

(57) ABSTRACT

A luminescent refrigerant gauge device has a body, a luminescent board, a case, a switch and a driving circuit device. The body has a valve body and a gauge body assembly. The luminescent boards are mounted inside the gauge body assembly. The case is mounted on the body. The switch is mounted inside the mounting hole in the gauge housing. The driving circuit assembly is mounted on the top of the valve body and is connected with the switch and the luminescent board. When the luminescent refrigerant gauge device is in use, a user can clearly read the measuring result of the gauge device in a dark environment without using an additional light source.

### BACKGROUND OF THE INVENTION

1. Field of the Invention

The present invention relates to a refrigerant gauge device, more particular to a luminescent refrigerant gauge device.

2. Description of Related Art

A conventional refrigerant gauge device is used for measuring air conditioner. The conventional refrigerant gauge device has a valve body, two knobs, two connectors, two gauges and a hook. The two knobs are mounted on the valve body and respectively control the two connectors. The two gauges respectively are connected to the connectors. The hook is mounted on the valve body between the gauges.

When the conventional refrigerant gauge device is in use, the hook on the refrigerant gauge device is hooked on the air conditioner and the connectors are connected to a tested object. However, when the working place is dim, an additional light source is needed for a user to clearly read the measuring data on the conventional gauge device. Since an additional light source and an additional power supply for the light source is always necessary for using the conventional refrigerant gauge device, the wire of the power supply will disorder the working place and the conventional refrigerant gauge device is trouble and inconvenient in use.

To overcome the shortcomings, the present invention tends to provide a refrigerant gauge device the aforementioned problems.

### SUMMARY OF THE INVENTION

The primary objective of the present invention is to provide a refrigerant gauge device that is conveniently for use.

A luminescent refrigerant gauge device has a body, a luminescent board, a case, a switch and a driving circuit device. The body has a valve body and a gauge body assembly. The luminescent boards are mounted inside the gauge body assembly. The case is mounted on the body. The switch is mounted inside the mounting hole in the gauge housing. The driving circuit assembly is mounted on the top of the valve body and is connected with the switch and the luminescent board. When the luminescent refrigerant gauge device is in use, a user can clearly read the measuring result of the gauge device in a dark environment without using an additional light source.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a refrigerant gauge device in accordance with the present invention;

FIG. 2 is a perspective view of the refrigerant gauge device in FIG. 1;

FIG. 3 is a side plan view in partial section of the refrigerant gauge device in FIG. 2; and

FIG. 4 is a diagram in partial section of the connection between a driving circuit device, a power supply and luminescent gauges of the refrigerant gauge device in FIG. 1.

### DETAILED DESCRIPTION OF THE PREFERRED EMBODIMENT

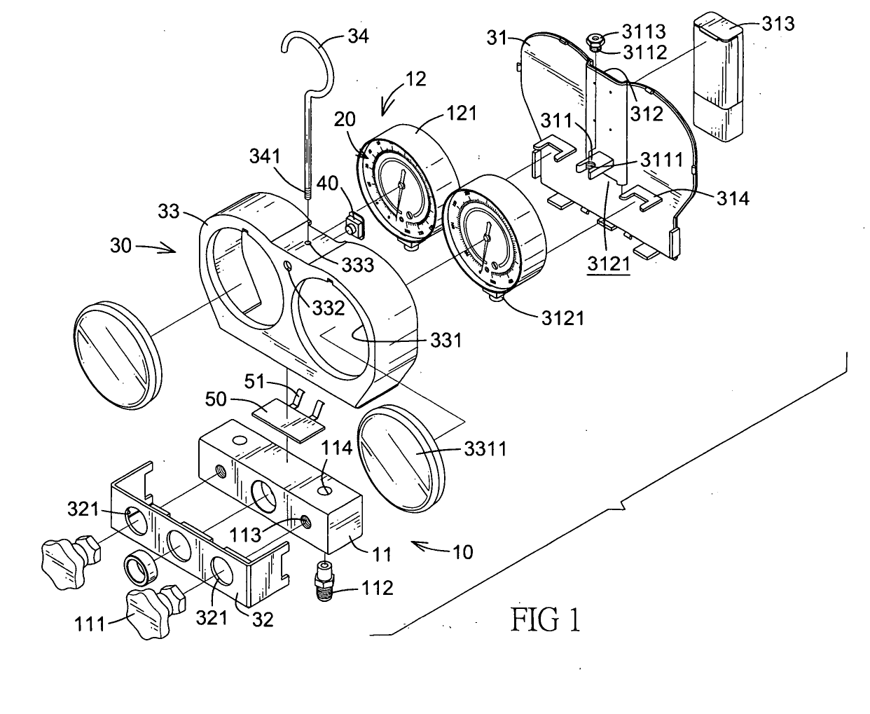

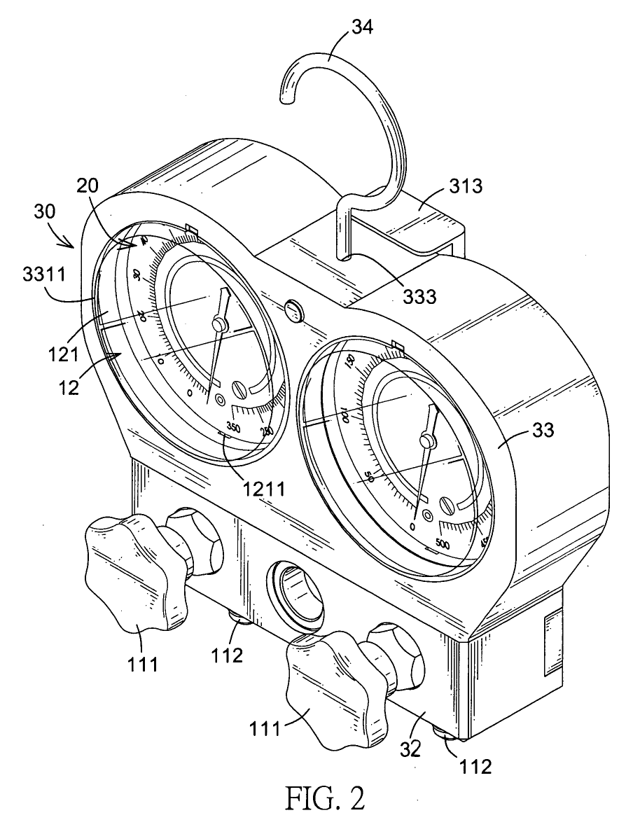

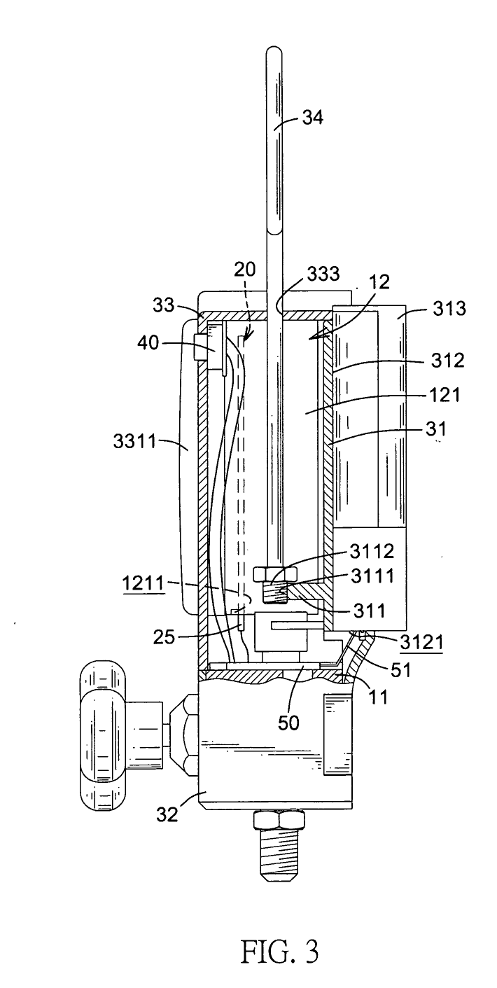

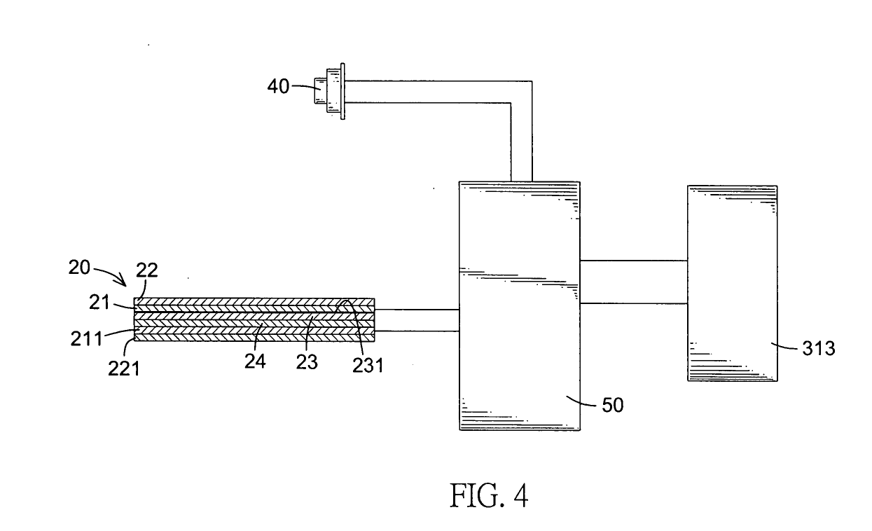

With reference to FIGS. 1 to 4, a luminescent refrigerant gauge device in accordance with the present invention comprises a body (10), two luminescent boards (20), a case (30), a switch (40) and a driving circuit assembly (50).

The body (10) has a valve body (11) and a gauge body assembly (12). The valve body (11) is a cuboid and has a top, a front surface, a rear surface, a bottom, two knobs (111), two connectors (112), two threaded holes (113) and two through holes (114). The threaded holes (113) are transversely defined in the body (11). The through holes (114) are longitudinally defined through the body (11) and respectively communicate with the threaded holes (113). The knobs (111) are respectively mounted on the threaded holes (113), and the connectors (112) are respectively mounted on the through holes (114) from the bottom of the valve body (11). The gauge body assembly (12) has two gauge bodies (121). In a preferred embodiment, each gauge body (121) has a sidewall with an inside surface and an outside surface, a gap (1211) and a channel (1212). The gap (1211) is defined in the inside surface of the sidewall. The channel (1212) is formed on the outside surface of the sidewall. Each channel (1212) of the gauge body (121) is mounted on a corresponding through hole (114) at the top of the body (11) and communicated with the connector (112).

Each luminescent board (20) is mounted inside the gauge body (121) and has a side edge, a front protecting plate (22), a first electrode layer (211), a luminescent layer (23), an insulating layer (24), a second electrode layer (21), a rear protecting plate (221) and an adapter (25). The second electrode layer (21) is mounted on the rear protecting plate (221). The insulating layer (24) is mounted on the second electrode layer (21). The luminescent layer (23) has a mark layer (231) with label, such as numbers. The mark layer (231) is formed on the luminescent layer (23). The luminescent layer (23) is mounted on the insulating layer (24). The first electrode layer (211) is mounted on the luminescent layer (23). The front protecting plate (22) is mounted on the first electrode layer (211). The adapter (25) is formed on the side edge of each luminescent board (20). In a preferred embodiment, the protecting plates (22, 221) are transparent, and in a more preferred embodiment, the protecting plates (22, 221) are transparent plastic plates. The adapter (25) is mounted in the gap (1211) in the gauge body (121).

The case (30) is mounted on the body (10) and has a support board (31), an optional valve housing (32), a gauge housing (33) and a hook (34).

The support board (31) has a front, a rear, an optional holder (311), an optional rear recess (312), a power supply (313) and two optional seats (314). The holder (311) is transversely mounted on the support board (31) at the front and has a threaded hole (3111) and a bolt (3112). The threaded hole (3111) is defined through the holder (311). The bolt (3112) is screwed into the threaded hole (3111) and has a top and a threaded hole (3113) defined in the top of the bolt (3112). The rear recess (312) is defined in the rear of the support board (31) and a communicating opening (3121) is defined in the support board (31) and communicating with the lower end of the rear recess (312). The power supply (313) is mounted on the rear of the support board (31), in a preferred embodiment, the power supply (313) is mounted inside the rear recess (312). Each seat (314) is separately mounted on the front of the support board (31) for supporting the gauge bodies (121). In a preferred embodiment, the holder (311) is mounted between the seats (314).

The valve housing (32) is mounted on the valve body (11) and has two through holes (321) through which the knobs (111) extend.

The gauge housing (33) is mounted on the support board (31) for receiving the gauge bodies (121) inside. The gauge housing (33) has a top, a front, two windows (331), two lenses (3311), a mounting hole (332) and a passing hole (333). Each window (331) is transversely defined through the gauge housing (33) and corresponds to the gauge body (121). The lenses (3311) are correspondingly mounted on the windows (331) and are transparent. The mounting hole (332) is defined through the gauge housing (33) at the front. In a preferred embodiment, the mounting hole (332) is defined between the windows (331). The passing hole (333) is defined through the gauge housing (33) at the top.

The hook (34) is mounted on the gauge housing (33) from the passing hole (333) and has a distal threaded end (341). The distal threaded end (341) is threaded in the threaded hole (3113) in the bolt (3112) threaded on the holder (311) of the support board (31).

The switch (40) is mounted inside the mounting hole (332) in the gauge housing (33).

The driving circuit device (50) is mounted on the top of the valve body (11) and is connected with the switch (40) and the adapter (25) of the luminescent board (20). The driving circuit device (50) has two legs (51) formed on the driving circuit device (50), a transformer element and a time prolonging element. Each leg (51) is connected to the power supply (313). The transformer is used for transferring a direct current (D.C.) output form the power supply to an alternating current (AC) and then transferring to the electrode layers (21, 211) of the luminescent board (20). The time prolonging element is used for prolonging the action between the switch (40) and the luminescent board (20). The prolong time is about 5 seconds.

When the refrigerant gauge device in accordance with the present invention is in use, the hook (34) is hooked on the air conditioner assembly of a car or an air conditioner. The connectors (112) are connected to a tested element, such as a refrigeratory machine in the car. When the switch (40) is pressed, the power supply (313) provides electrical power to the luminescent board (20) and prolong for about 5 seconds, therefore, a user may read the measuring data from the refrigerator gauge device conveniently and clearly even when the working space is dim.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A luminescent refrigerant gauge device comprising:
a body having
a valve body having
two threaded holes transversely defined in the body,
two through holes longitudinally defined through the body and respectively communicate with the threaded holes,
two knobs respectively mounted on the threaded holes,
two connectors respectively mounted on the through holes, and
a gauge body assembly having two gauge bodies,
two luminescent boards respectively mounted inside the gauge bodies,
a case mounted on the body and having
a support board having
a front,
a rear, and
a power supply mounted on the rear of the support board,
a gauge housing mounted on the support board for receiving the gauge bodies and having
a top,
a front,
two windows transversely defined through the gauge housing and corresponding respectively to the gauge bodies,
two lenses correspondingly mounted on the windows and being transparent,
a mounting hole defined through the gauge housing, and
a passing hole defined through the gauge housing, and
a hook mounted on the gauge housing at the passing hole,
a switch mounted inside the mounting hole in the gauge housing, and
a driving circuit assembly mounted on the top of the valve body and connected with the switch and the luminescent board.

2. The luminescent refrigerant gauge device as claimed in claim 1, wherein
each gauge body further comprises
a sidewall with an inside surface and an outside surface,
a gap defined in the inside surface of the sidewall, and
a channel formed on the outside surface of the sidewall, and
each luminescent board further comprises
a side edge,
a rear protecting plate,
a first electrode layer mounted on the rear protecting plate,
an insulating layer mounted on the second electrode layer,
a luminescent layer having a mark layer with label formed on the luminescent layer and mounted on the insulating layer,
a second electrode layer mounted on the luminescent layer, and
a front protecting plate mounted on the first electrode layer,
an adapter formed on the side edge of each luminescent board and mounted in the gap in the gauge body for connecting to the driving circuit device.

3. The luminescent refrigerant gauge device as claimed in claim 2, wherein the support board of the case has
a front,
a rear,
a holder transversely mounted on the support board at the front and having
a threaded hole, and
a bolt threaded on the threaded hole and having a top and a threaded hole defined in the top of the bolt for holding the hook, and
two seats separately mounted on the front of the support board for supporting the gauge bodies.

4. The luminescent refrigerant gauge device as claimed in claim 3, wherein the support board of the case further comprises
a rear recess defined in the rear of the support board for receiving the power supply and a communicating opening defined in the support board and communicating with the rear recess.
